(19) United States
(12) Patent Application Publication
(10) Pub. No.: US 2022/0304249 A1
(43) Pub. Date: Sep. 29, 2022

(54) MODULAR ECOLOGICAL SYSTEM FOR WALLS

(71) Applicant: Christopher Todd WENTE, Sõlvesborg (SE)

(72) Inventor: Christopher Todd WENTE, Sõlvesborg (SE)

(21) Appl. No.: 17/216,641

(22) Filed: Mar. 29, 2021

(51) Int. Cl. A01G 9/02; A01K 31/00

(52) U.S. Cl. CPC A01G 9/025; A01K 31/00

(57) ABSTRACT

A modular ecological system for walls that houses plants, animals, and insects.

### CLAIM OF PRIORITY

This application is a continuation in part application and claims priority to U.S. patent application Ser. No. 29/749,466, filed Sep. 4, 2020 entitled “Modular Wall Planter”, the contents of which are incorporated herein by reference in its entirety.

### FIELD OF THE INVENTION

The present invention relates to a wall system for housing and growing biological materials within containers, more specifically for plants, birds and other small mammals, and insects. The wall system is modular for adaptation to different conditions and for covering various surface areas.

### BACKGROUND

With both urban and suburban density and global food demands continuing to rise, vertical gardens systems have proven a highly effective means of producing large volumes of vegetables and other edible or similarly valuable floral species within relatively small footprints while also providing vertical green spaces that reduce heat (both within the localized outdoor area and within the structures that are supporting them) and offset carbon dioxide levels. Because of the proven physical and psychological benefits that green spaces provide to residents of urban areas, more large cities and urban municipalities are requiring forthcoming urban designs to include layouts and embedded structures, such as vertical gardens, that meet a defined Green Space Factor (GSF), with said GSF intended to ensure that local plants and animal species are being accommodated.

While the prior art has provided vertical green space solutions in a utilitarian manner, it has failed to address the need for easy and rapid flexibility for alteration of the garden's base structure and modular component assembly, scale, and functionality. Furthermore, the prior art fails to incorporate ecologically critical features such as animal or insect housing pods directly into their designs. By offering not simply a vertical “plants-only” garden structure, but a scalable vertical framework of housing pods for the containment of plants, animals and insects, the present invention makes possible a truly bio-diverse vertical garden that 1) can increase the success for plant pollination, fruit production and overall garden health, 2) can support localized environmental needs, including the re-population of native bird and plant-pollinating insect species which are showing an alarming decline in population, 3) can easily be modified or expanded to accommodate the changing needs or desires of the gardener or larger community in which it resides.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of various exemplary embodiments, a modular ecological wall system for containing botanical and biological life forms, comprising at least one pod having a front housing and a rear housing, at least one mounting frame with a perimeter shape that permits being disposed flush to adjacent mounting frames to form a repeating pattern, the at least one mounting frame further comprising a plurality of spacers for offsetting the mounting frame from a wall surface, at least one void for accepting the at least one pod, and a plurality of tabs extending into the at least one void with each tab having a hole, and a plurality of fasteners to removably secure the at least one pod to the at least one mounting frame disposed therebetween thereby forming a cavity when the at least one pod is positioned over the at least one void, whereby the plurality of fasteners pass through each of the holes.

In another aspect of various exemplary embodiments, a modular ecological wall system for containing botanical and biological life forms, comprising a plurality of pods, each of the pods having a front housing and a rear housing, at least one mounting frame with a perimeter shape that permits being disposed flush to adjacent mounting frames to form a repeating pattern, the at least one mounting frame further comprising a plurality of spacers for offsetting the mounting frame from a wall surface, a plurality of voids for accepting the pods, and a plurality of tabs extending into the at least one void with each tab having a hole, and a plurality of fasteners to removably secure the pods to the mounting frame disposed therebetween thereby forming a cavity when the pods are positioned over the voids, whereby the fasteners pass through each of the holes.

In still another aspect of various exemplary embodiments, a modular ecological wall system for containing botanical and biological life forms, comprising a plurality of pods, each of the pods having a rear housing and a front housing, a plurality of mounting frames, each of the mounting frames having a perimeter shape that permits being disposed flush to adjacent mounting frames to form a repeating pattern, the mounting frames further comprising a plurality of spacers for offsetting the mounting frames from a wall surface, a plurality of voids for accepting the pods, and a plurality of tabs extending into the at least one void with each tab having a hole, and a plurality of fasteners to removably secure the pods to the mounting frame disposed therebetween thereby forming a cavity when the pods are positioned over the voids, whereby the fasteners pass through each of the holes.

### BRIEF DESCRIPTION OF THE DRAWINGS

FIG. 1 is an isometric view of an embodiment system with a portion exploded to demonstrate components of the assembly.

FIG. 2 is a front view of an embodiment system that illustrates mounting frames adjacently placed to another.

FIG. 3 is a front view of an embodiment system that illustrates another configuration of mounting frames adjacently placed to another.

FIG. 4 is an isometric view of an embodiment system having different rear enclosures matched to the same front enclosure.

FIG. 5 is an isometric view of an embodiment system with an identical front and rear enclosure that spans two voids.

FIG. 6 is an isometric view of an embodiment system illustrating one configuration of multiple housings and multiple frames.

FIG. 7 is an isometric view of an embodiment system having two rear enclosures matched to a single front enclosure.

FIG. 8A is an isometric exploded view of an embodiment system illustrating the assembly of two front enclosures to the frame.

FIG. 8B illustrates FIG. 8A without the exploded view.

FIG. 8C illustrates FIG. 8B with an exploded view of an embodiment system illustrating the assembly of two rear enclosures to the frame.

FIG. 8D illustrates FIG. 8C without the exploded view.

FIG. 9 is an isometric exploded view of an embodiment system illustrating the assembly of front and rear enclosures to the frame with a different fastener configuration.

FIG. 10 is an isometric view of several embodiments of the front and rear enclosure configurations.

FIG. 11A is a cross-section view of an embodiment system to illustrate one fastener configuration.

FIG. 11B is a cross-section view of an embodiment system to illustrate an alternate fastener configuration.

### DETAILED DESCRIPTION

In the following detailed descriptions of various exemplary embodiments, reference is made to the accompanying drawings that form a part hereof, and in which is shown, by way of illustration, specific embodiments that may be practiced. It is to be understood that other embodiments may be utilized and structural changes may be made without departing from the scope of the present disclosure.

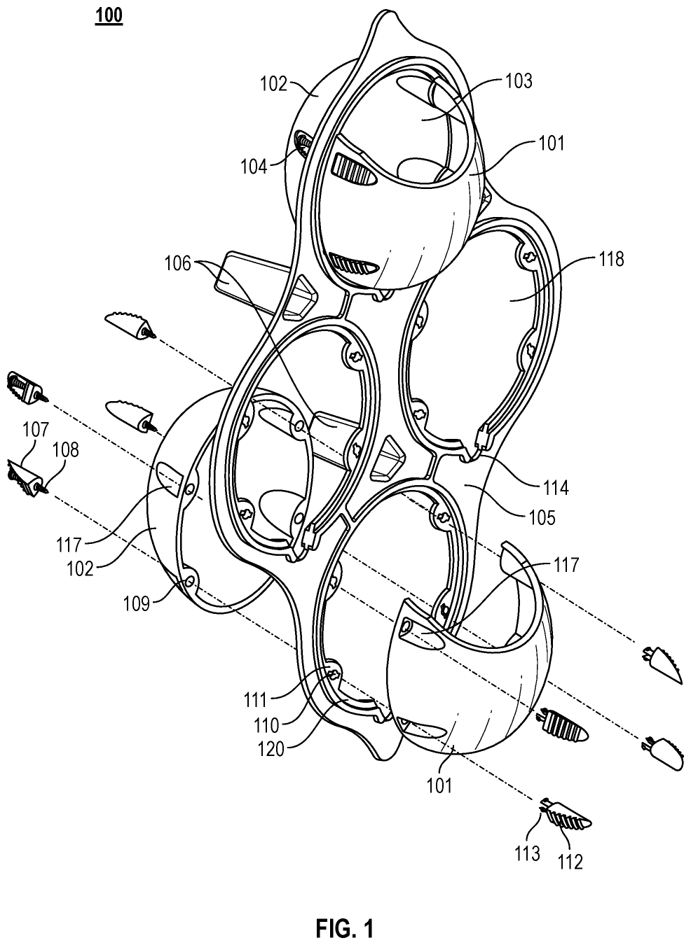

The present disclosure generally comprises a modular, highly configurable wall system for housing and growing biological materials within containers, more specifically for plants, birds and other small mammals, and insects. The wall system 100 as illustrated in FIG. 1 is one such embodiment that features a single frame 105 with a plurality of spacers 106, pods 101,102, and fasteners 107,108,112 to join the pods 101,102 to the frame 105. The frame 105, which may be made from thermoplastic or other formable material that resists degradation by moisture and UV light, mounts to a wall surface (not shown) with anchors (not shown) such as screws, bolts, spikes, and so forth through each of the plurality of spacers 106, which offsets the frame 105 from a wall surface. The spacer 106 length must be sufficient to position the frame 105 away from the wall surface to accommodate a rear housing 102 when joined to the frame 105. In that respect, the depth of the rear housing 102 is ordinarily less than the length of the spacer 106 or, said differently, the offset distance from the wall surface created by the length of the spacers 106 is normally greater than the rear housing 102 thickness. The frame 105 may have three spacers 106 for creating a stable connection to the wall and permitting sufficient shear strength for wall anchors to resist the weight of the wall system 100 plus the contents, such botanical specimens.

A pod 101,102 comprises a front housing 101 and rear housing 102 when positioned over one of the several voids 118 (four voids as illustrated) and then joined to the frame 105. It should be noted that the illustration contains only two pods 101,102 for simplicity. Hence, in the embodiment depicted in FIG. 1, a total of four pods 101,102 may be attached to the frame. The pods 101,102 may be made from thermoplastic or other formable material that resists degradation by moisture and UV light. The front housing 101 and rear housing 102 may be removably joined to the frame 105 with a flange 120, which may be part of the frame 105, sandwiched in between the housings 101,102. Each flange 120 may comprise one or more tabs 111. Each of the tabs 111 may contain holes 110, or may be partial holes to facilitate manufacturing, whereby fasteners 107,108,112 pass through and join with a mating plug 112. When tightened, these fasteners 107,108,112 provide the clamping force necessary to restrain the pod 101,102 against the frame 105. Plants, dirt, birds, and other botanical or biological specimens may then be contained within the volume 103 created therein. One or more drains 114 may be provided at the base of the pod 101,102 when attached to the frame 105 to permit water from pooling inside the volume 103, or to circulate air within the volume 103.

Each of the housings 101,102 may have indentations 117 to accommodate the fasteners 107,108,112 in order to partially conceal their presence by matching the contour of the external surface of the housings 101,102. Attachment of the housings 101,102 onto the frame 105 may occur before or after installation of the frame 105 onto a wall surface, depending on the preference of the installer. This is because the fasteners 107,108,112 are reversible; i.e. can be installed from the front or the rear of the frame 105. If the preference is to keep the screws 108 hidden from view in order to provide a more visually pleasing aesthetic of the finished installation, then the installer may prefer to attach the pods 101,102 onto the frame 105 before installing the frame 105 onto the wall surface because it may be easier to access the heads of the screws 108. To facilitate attachment of the pod 101,102 onto the frame 105, the plug 112 may comprise snapping tangs 113 that, when inserted through holes 109 in the housing 101,102, may at least temporarily clamp the housing 101,102 to the frame 105. More secure clamping is obtained when the carrier 107 and fastener 108 are removably secured to the plug 112.

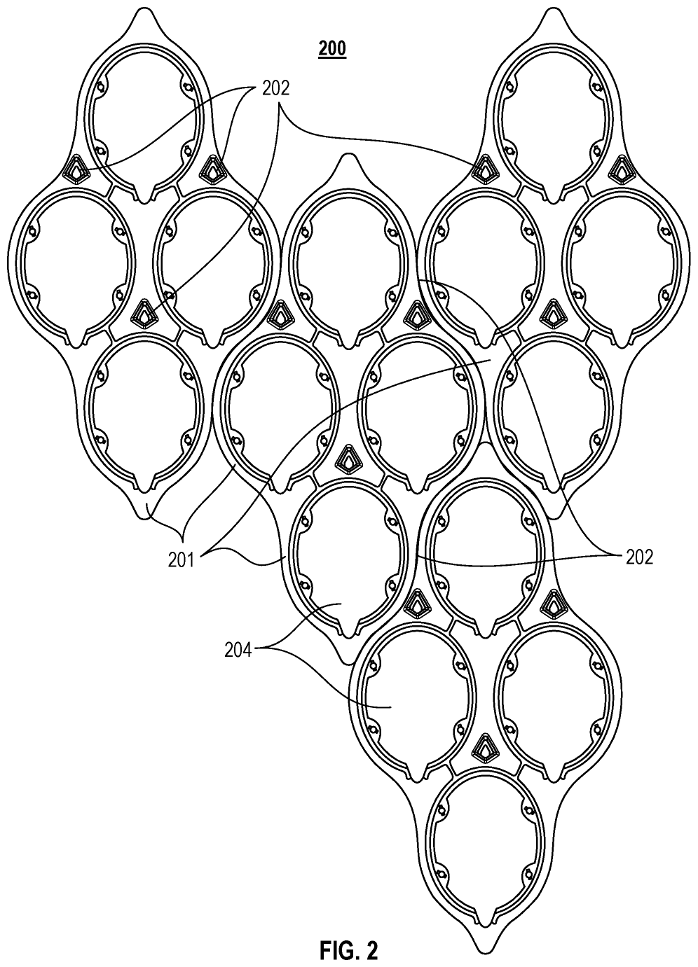

FIG. 2 illustrates multiple frames 201 of an embodiment wall system 200, which may interconnect when abutted along their perimeter edges 203, as viewed from the front elevation. This elevation view also permits the reader to identify the spacers 202 for each frame 201, through which anchors (not shown) may be used to attach the frame to a wall surface (not shown). Holes may or may not be provided at the bottom of the spacer 202 to permit the anchors to pass through the frame 201. Pods and fasteners are not shown in FIG. 2 for clarity, but a person skilled in the art can imagine nearly infinite wall system configurations using hundreds of frames and thousands of pods. Spacers 202 and voids 204 may be placed in the surface of each frame 201 in such a manner as to make efficient use the frame 201 surface area, or put another way, to increase the number of pods that mount to a wall that accept the pods. In this way, the spacers 202 and voids 204 are said to be arranged in a staggered pattern.

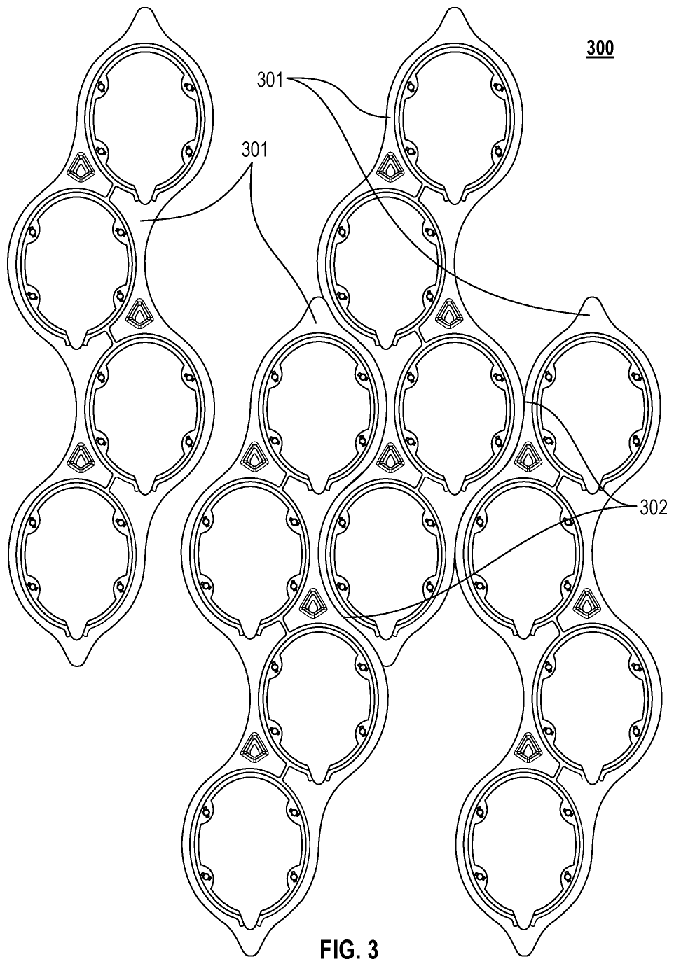

FIG. 3 illustrates another embodiment wall system 300 having multiple frames 301, which may interconnect when abutted along their perimeter edges 302 as viewed from the front elevation. While FIGS. 2-3 illustrate only two embodiments, a person skilled in the art can conceive myriad different shapes that enable multiple frames to be installed adjacent to one another in order to permit continuous wall coverage.

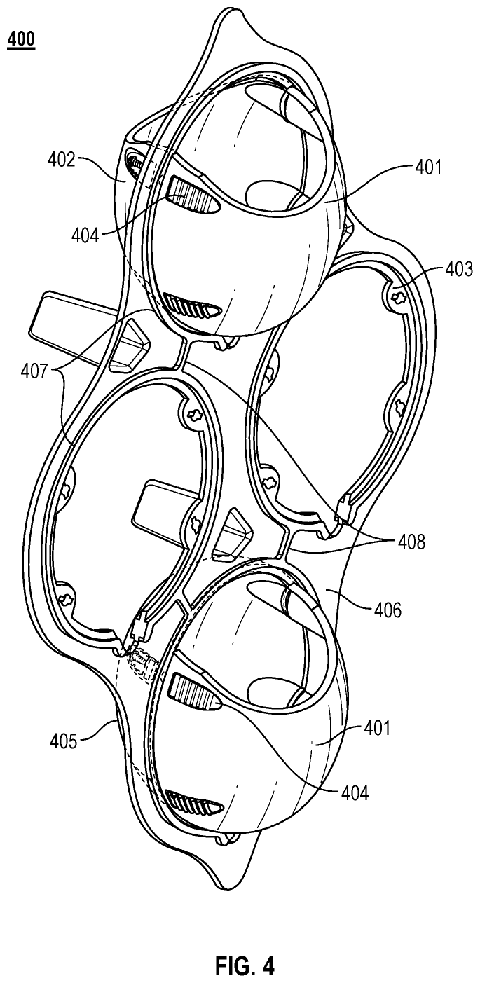

The wall system 400 as illustrated in FIG. 4 is another embodiment that depicts front housings 401 and rear housings 402,405 attached to a frame 406 with plugs 404 and fasteners (not shown). Rear housing 402 may be identical to front housing 401 in order to make them reversible and to create a larger opening at the top for plants to more easily grow and spread. In an embodiment, the frame 406 may have raised ribs 407,408 to improve structural rigidity. Additionally, the ribs 407 may facilitate installation of housings 401,402,405 to the frame 406 and improve sealing around the perimeter of the housings 401,402,405.

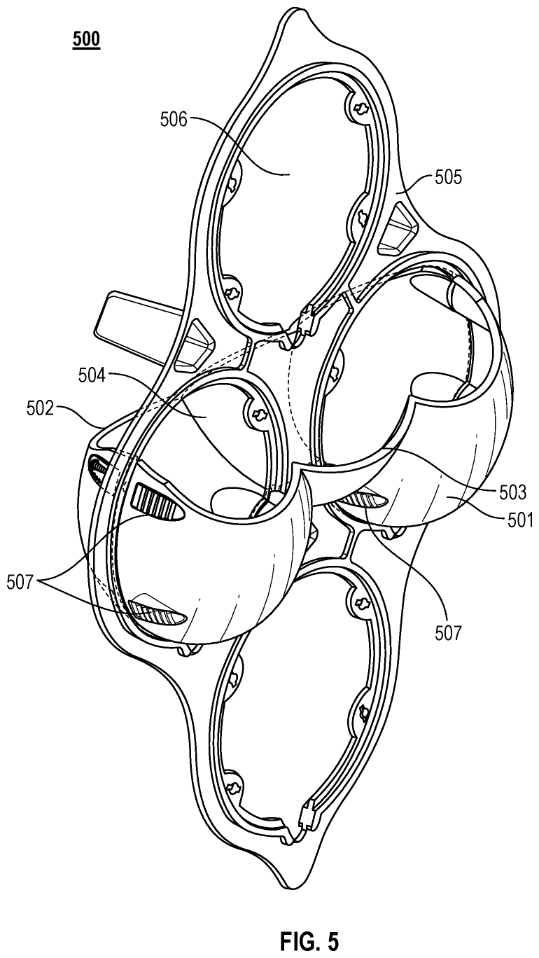

The wall system 500 as illustrated in FIG. 5 is an embodiment that depicts a front housing 501 and rear housing 502 that, when attached to the frame 505, span at least two voids 506 of the frame 505, thereby creating a larger volume 504. In this configuration, the housings 501,502 may require additional fasteners 507 to provide adequate clamping force. Further, the housings 501,502 may have convex wall section 503 between the main cavities to create a larger total volume 504 between the frame voids 506.

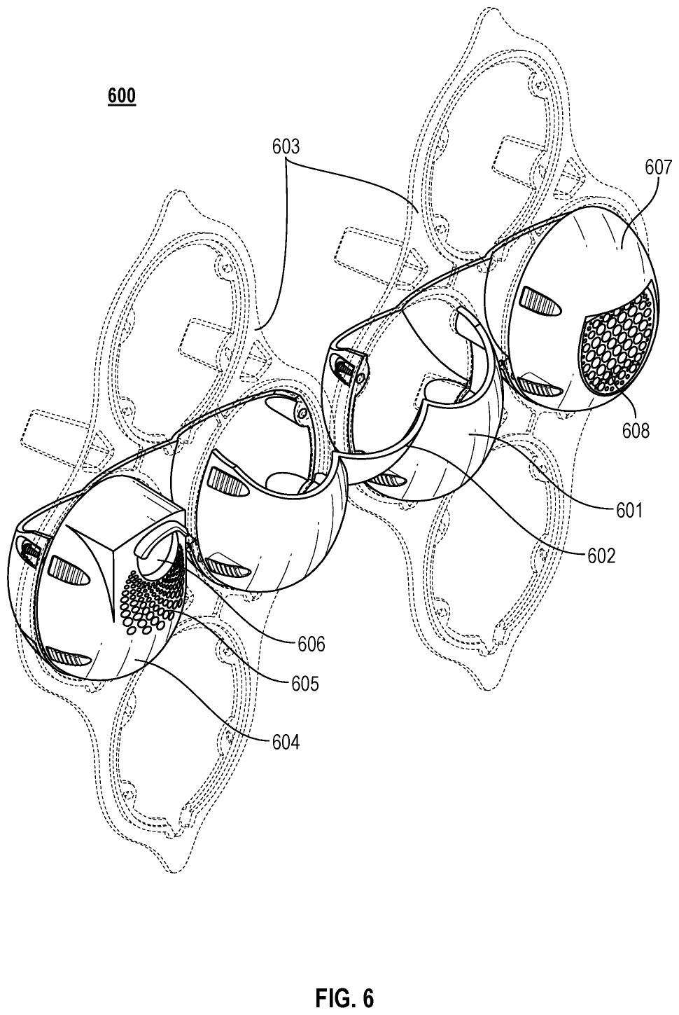

In FIG. 6, the wall system 600 is an embodiment that depicts how multiple frames 603 may interact with a single front housing 601, and other embodiment pods 604,607. When a housing 601 spans multiple frames 603 may improve overall rigidity of the wall system 600 because multiple fastening points across multiple frames will create a more unibody-like construction when mounted to a wall surface. Pod 604 depicts an embodiment for housing birds or other small creatures. The small circular features 605 provide a textured surface for a bird to more easily grip when entering or exiting the pod 604 through the entrance 606. Pod 607 depicts an embodiment that may have multiple entrances 608 to house insects or permit plants to grow outward.

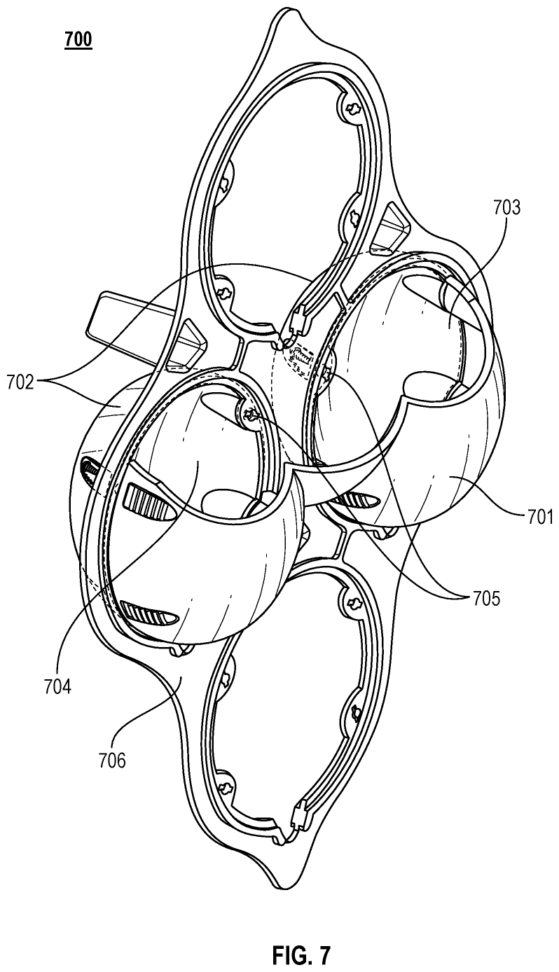

FIG. 7 is illustrative of an embodiment wall system 700 with a single front house 701 and two rear housings 702. In this configuration, there are two volumes 703,704 that are created once the housings 701,702 are joined to the frame 706. When removably fastened to the frame 706, each housing 702 may use fewer holes than provided in the frame 706. However, to maintain sufficient clamping force, the fasteners may be terminated into nuts 705, which may be wingnuts or another component that will accept a threaded fastener.

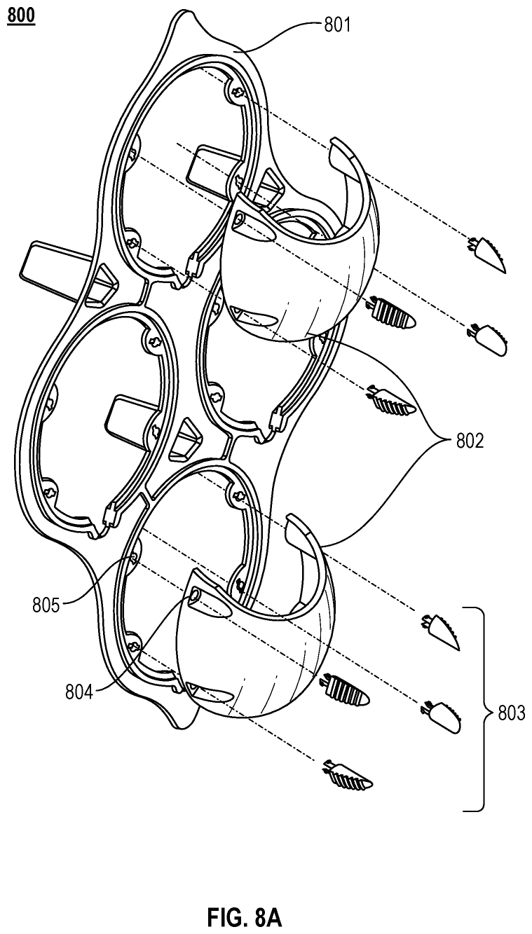

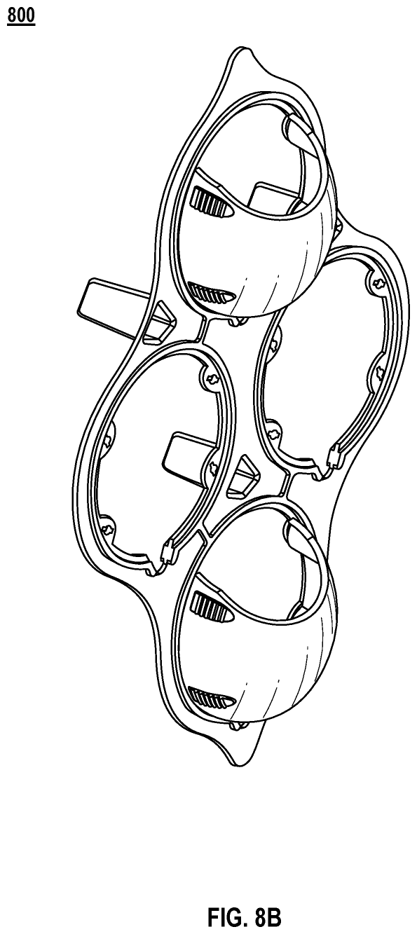

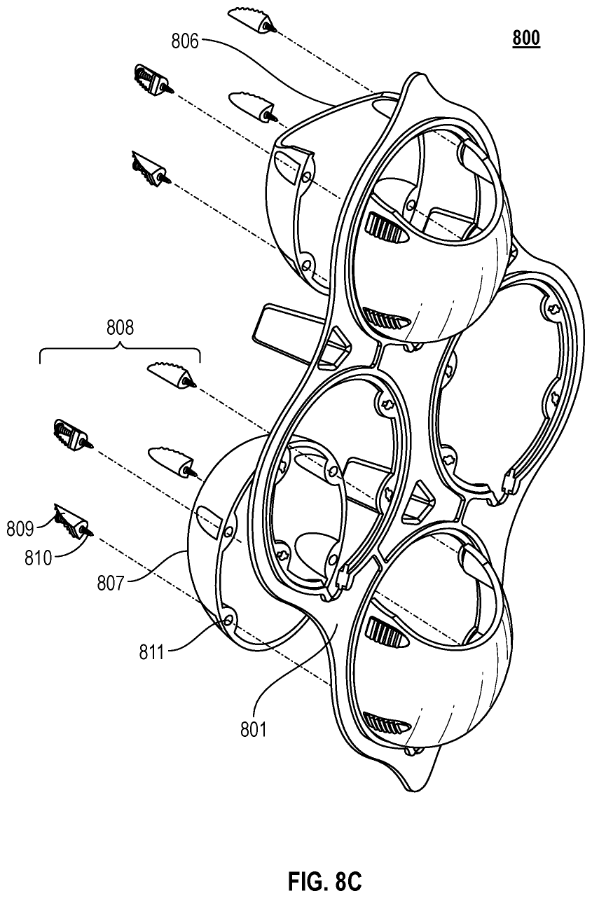

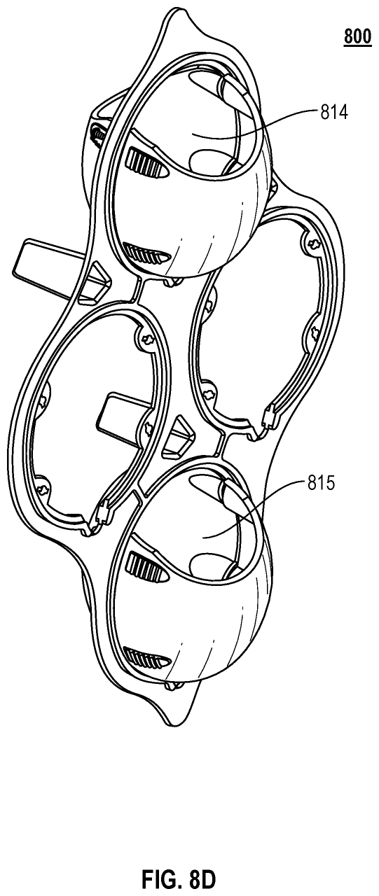

FIG. 8A-8D depict an embodiment wall system 800 that illustrate an order of assembly steps using alternating exploded views and isometric views. In FIG. 8A, the process begins by mating housings 802 to frame 801. Next, plugs 803 are inserted through holes 804 in the housings 802 and then through holes 805 in the frame 801, thereby at least temporarily clamping the housings 802 to the frame 801. FIG. 8B shows the completed assembly of the front housings 802 to the frame 801.

FIG. 8C is a partially exploded wall system 800 that depicts the order of assembly of the rear housings 806,807 and fasteners 808 to the frame 801, front housings 802, and plugs 803. Each of the fasteners 808 may comprise a carrier 809 and a threaded screw. Each of the screws 810 may pass through a corresponding hole 811 in the rear housing 806,807. FIG. 8D shows the completed assembly of the front housings 802, plugs 803, rear housings 806,807, and fasteners 808 to the frame 801. Hence, volumes 814,815 are created for containing biological materials.

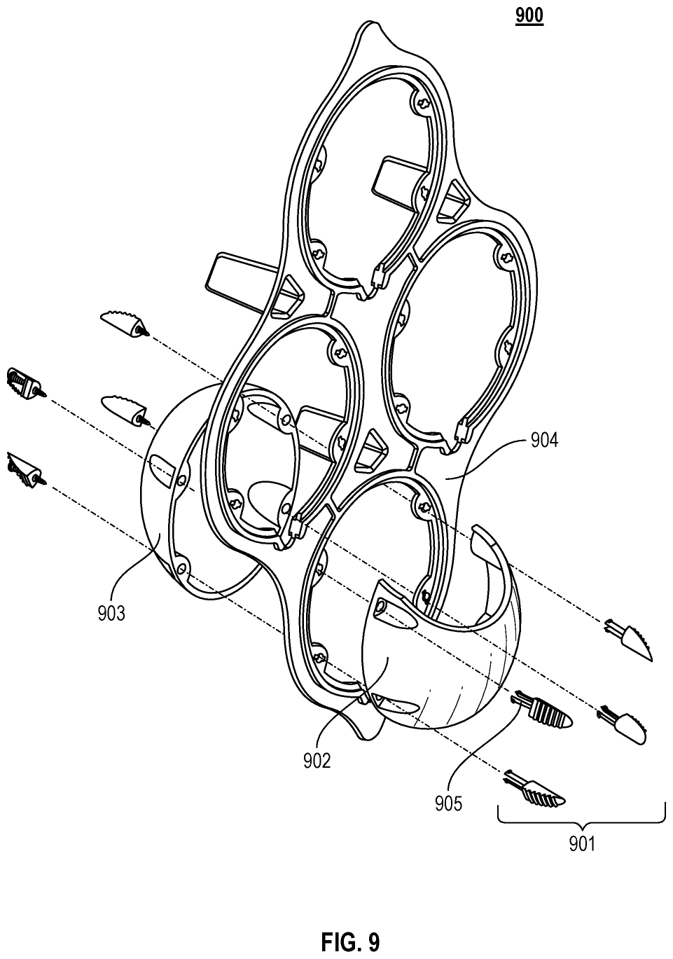

FIG. 9 is an embodiment wall system 900 exploded to illustrate another configuration of plugs 901 with longer snapping tangs 905. These tangs 905 which may simultaneously clamp the front housing 902 and rear housing 903 to the frame 904.

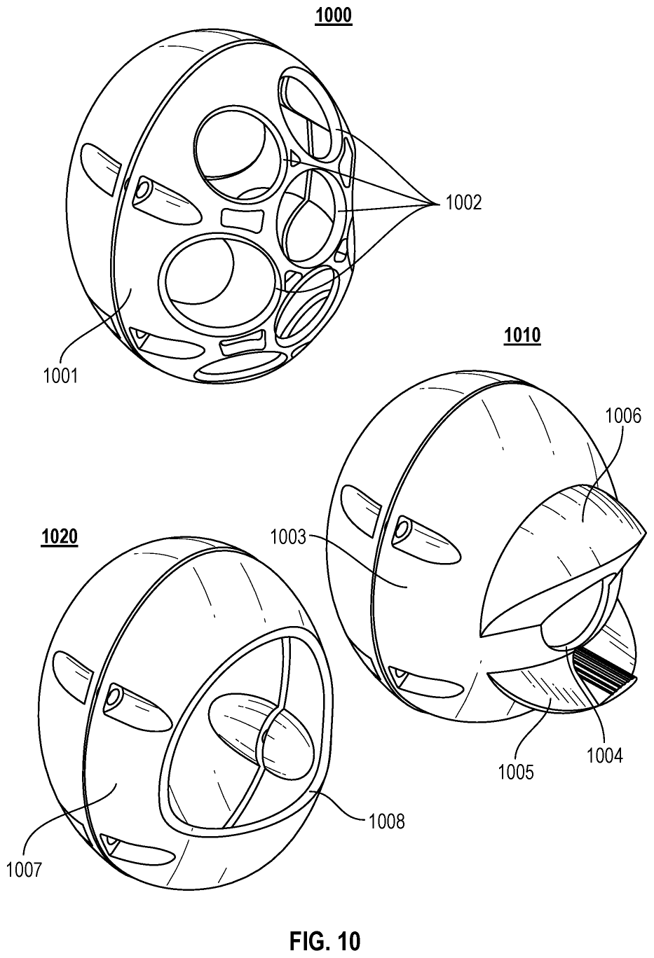

FIG. 10 depicts three embodiment pods 1000,1010,1020 to illustrate alternate forms in which can be imagined. Front housing 1001 may have several large holes 1002 in order to provide an anchor point for climbing and/or vining flora or as an open-fronted bird house configuration which is desired by some species. Front housing 1003 may have an entrance 1004 for a bird house with a perch 1005 and an awning 1006. Front housing 1007 may have a single, front-positioned large opening 1008 for shade-needing plants (for example, succulents) or as an open-fronted bird house configuration which is desired by some species.

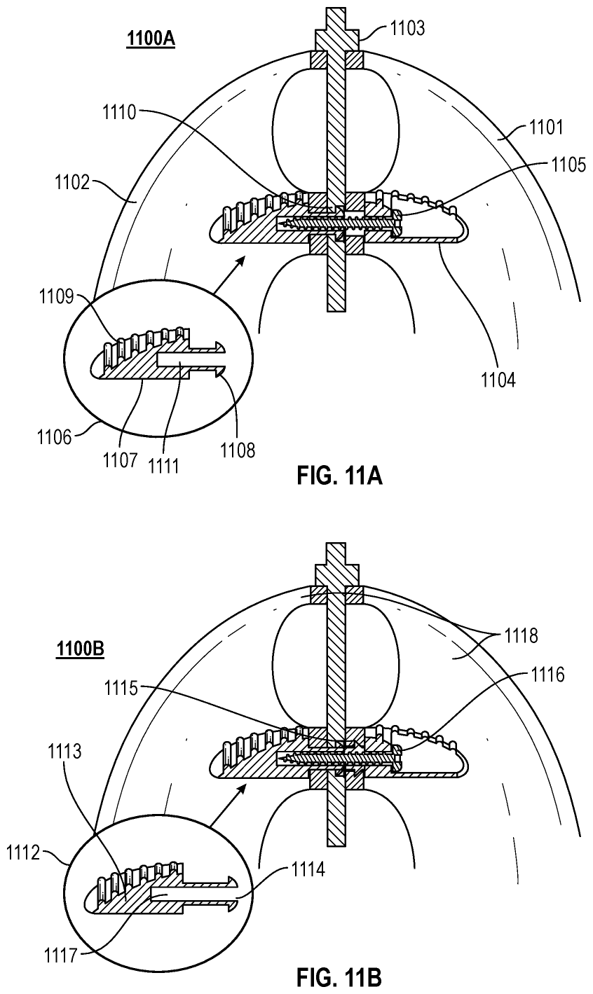

FIG. 11A depicts a partial cross-section view of an embodiment wall system 1100A. Front housing 1101 and rear housing 1102 may be joined to the frame 1103 by a fastener 1105, a fastener carrier 1104, and a plug 1107. An enlarged view 1106 of the plug 1107 illustrates how the plug may have snapping tangs 1108, a receptacle 1111 for the fastener 1105, and raised thumb strips 1109 to increase friction during removal of the plug 1107. When fully inserted, the snapping tangs 1108 of the plug 1107 may engage a stepped recess 1110 of the frame 1103. This action may permit at least temporary installation of the housing 1102 onto the frame 1103. After the plug 1107 is installed, the fastener 1105 may then engage the receptacle 1111, which may or may not be threaded (depending on whether the fastener is a thread-forming type), to provide a more securely clamped connection.

FIG. 11B depicts a partial cross-section view of an embodiment wall system 1100B. An enlarged view 1112 depicts an embodiment of the plug 1113 having elongated snapping tangs 1114 and a receptacle 1117 for the fastener 1116. When fully inserted, the snapping tangs 1114 of the plug 1113 may engage a stepped recess 1115 of the housings 1118. This action may permit at least temporary installation of the housings 1118 onto the frame 1103. After the plug 1107 is installed, the fastener 1116 may then engage the receptacle 1117 which may or may not be threaded (depending on whether the fastener is a thread-forming type), to provide a more securely clamped connection.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A modular ecological system for walls, comprising:
at least one pod having a front housing and a rear housing,
at least one mounting frame with a perimeter shape that permits being disposed flush to adjacent mounting frames to form a repeating pattern, the at least one mounting frame further comprising
a) a plurality of spacers for offsetting the mounting frame from a wall surface,
b) at least one void for accepting the at least one pod, and
c) a plurality of tabs extending into the at least one void with each tab having a hole, and
a plurality of fasteners to removably secure the at least one pod to the at least one mounting frame disposed therebetween thereby forming a cavity when the at least one pod is positioned over the at least one void, whereby the plurality of fasteners pass through each of the holes.

2. The modular ecological system of claim 1 wherein each of the fasteners further comprise a plug, a carrier, and a threaded fastener.

3. The modular ecological system of claim 2 wherein the plug comprises a plurality of snapping tangs that removably joins the rear housing or front housing to the frame.

4. The modular ecological system of claim 2 wherein the plug comprises a plurality of snapping tangs that removably joins the rear housing and front housing to the frame.

5. The modular ecological system of claim 1 wherein each of the fasteners are insertable from a front of the pod and a rear of the pod.

6. The modular ecological system of claim 1 wherein the front housing and the rear housing are capable of creating multiple cavities when joined to the mounting frame.

7. The modular ecological system of claim 1 wherein the pod perimeter substantially matches the void perimeter.

8. The modular ecological system of claim 1 wherein the frame comprises a drain at the base of the at least one void.

9. The modular ecological system of claim 1 wherein the pods are used for planting botanical specimens.

10. The modular ecological system of claim 1 wherein the pods are used for housing birds.

11. The modular ecological system of claim 1 wherein the pods are used for housing insects.

12. A modular ecological system for walls, comprising:
A plurality of pods, each of the pods having a front housing and a rear housing,
at least one mounting frame with a perimeter shape that permits being disposed flush to adjacent mounting frames to form a repeating pattern, the at least one mounting frame further comprising
a) a plurality of spacers for offsetting the mounting frame from a wall surface,
b) a plurality of voids for accepting the pods, and
c) a plurality of tabs extending into the at least one void with each tab having a hole, and
a plurality of fasteners to removably secure the pods to the mounting frame disposed therebetween thereby forming a cavity when the pods are positioned over the voids, whereby the fasteners pass through each of the holes.

13. The modular ecological system of claim 12 wherein the front housing further comprises indentations on the exterior surface to accept fasteners that are shaped to match the contour of the housing.

14. The modular ecological system of claim 12 wherein the frame comprises a drain at the base of the at least one void.

15. A modular ecological system for walls, comprising:
A plurality of pods, each of the pods having a rear housing and a front housing,
a plurality of mounting frames, each of the mounting frames having a perimeter shape that permits being disposed flush to adjacent mounting frames to form a repeating pattern, the mounting frames further comprising
a) a plurality of spacers for offsetting the mounting frames from a wall surface,
b) a plurality of voids for accepting the pods, and
c) a plurality of tabs extending into the at least one void with each tab having a hole, and
a plurality of fasteners to removably secure the pods to the mounting frame disposed therebetween thereby forming a cavity when the pods are positioned over the voids, whereby the fasteners pass through each of the holes.

16. The modular ecological system of claim 15 wherein each of the fasteners are insertable in the front housing or rear housing thereby being reversible.

17. The modular ecological system of claim 15 wherein the front housing and the rear housing are capable of creating multiple cavities when joined to the mounting frame.

18. The modular ecological system of claim 15 wherein the voids and spacers are arranged in a staggered pattern within the surface of the frame for more efficient use of space.

19. The modular ecological system of claim 1 wherein the pods are used for planting botanical specimens.

20. The modular ecological system of claim 1 wherein the pods are used for housing birds.
